(19) United States
(12) Patent Application Publication
(10) Pub. No.: US 2025/0020181 A1
(43) Pub. Date: Jan. 16, 2025

(54) FRICTION MATERIAL AND CORRESPONDING DISC BRAKE PAD

(71) Applicant: Brembo S.p.A., Curno, Bergamo (IT)

(72) Inventors: Paolo VAROTTO, Curno, Bergamo (IT); Matteo REDAELLI, Curno, Bergamo (IT); Luca MAESTRINI, Curno, Bergamo (IT); Cristian MALMASSARI, Curno, Bergamo (IT)

(21) Appl. No.: 18/710,639

(22) PCT Filed: Nov. 17, 2022
(86) PCT No.: PCT/IB2022/061078

§ 371 Date: May 16, 2024

(30) Foreign Application Priority Data
Nov. 19, 2021 (IT) 102021000029270

(51) Int. Cl. F16D 69/02; F16D 55/02; F16D 65/092; F16D 69/00

(52) U.S. Cl. CPC F16D 69/026; F16D 55/02; F16D 65/092; F16D 2069/002; F16D 2200/0065

(57) ABSTRACT

A friction material, a corresponding disc brake pad, and a braking system having the pad, in which the so-called “creep groan” phenomenon is suppressed or significantly mitigated. The material may be a graphite-free friction material having from 20 to 30% by volume of one or more abrasives, from 10 to 20% by volume of coke, up to 10% by volume of one or more metal sulfides, up to 20% by volume of one or more metals and/or metal alloys and/or intermetallic compounds in powder form, up to 40% by volume of a fibrous material comprising aramid fiber and steel fiber, from 10 to 20% by volume of phenolic resin as a binder and up to 10% by volume of one or more fillers that may be: calcium hydroxide, friction powder, PTFE, and fluorite.

### FIELD OF THE INVENTION

The present invention relates to a friction material, a disc brake pad comprising a friction layer made of said material, and a braking system comprising said pad.

### BACKGROUND ART

Asbestos- and heavy metal-free friction materials for brake pads typically comprise the following classes of components: a fibrous material consisting of inorganic and/or organic and/or metal fibers; one or more abrasives; one or more binders; one or more fillers; one or more lubricants or friction modifiers. The most widely used lubricant is graphite; an example of friction material comprising graphite is described in CN110878802.

However, vehicles using brake pads made with the aforesaid friction materials can generate a bothersome vibration phenomenon, so-called “creep groan”, which is a problem of primary importance as for the NVH behavior (Noise, Vibration and Harshness) in the automotive field, in particular as for combustion and/or electric vehicles. The NVH behavior is also known as the NVH performance level.

Such a phenomenon is triggered by the alternating adhesion condition and slip condition by the brake pad in contact with the surface of the brake disc, also known as the “stick-slip” effect, or simply “stick-slip”, i.e., the repeated switching between static friction and dynamic friction. The latter causes a dynamic response of the vehicle in terms of particularly bothersome noises and vibrations which can be perceived in the passenger compartment.

The stick-slip, and thus the response of the vehicle in terms of “creep groan”, occur under speed conditions close to zero and with the presence of a static or almost static braking torque, for example concurrently with the gradual release of the brake pedal downhill or with the starting with automatic transmission.

The alternation between static friction and dynamic friction causes the behavior of the braking system, with respect to the “creep groan” phenomenon, to be strongly linked to the environmental conditions, in particular to the temperature and the humidity.

Various proposals are known in the art aimed at mitigating the “creep groan” phenomenon, therefore at reducing the noise and the vibrations associated with the braking system of a vehicle.

For example, EP 959 262 describes a brake pad obtained using a composition comprising a modified silicone resin as a binder and a zeolite as a friction modifier. The specific compositions described in such a document comprise graphite.

Other proposals are described, for example, in WO 2020/189649 and JP 2002-266915; all the specific compositions described therein also contain graphite.

Nevertheless, the need to develop further compositions for friction materials capable of suppressing, or at least significantly reducing, the “creep groan” phenomenon is increasingly felt. Therefore, the problem underlying the present invention is to provide a friction material for brake pads which reduces the noise and the vibrations associated with the braking system of a motor vehicle, resulting in an improvement of the NVH behavior representative of the measurement of the vehicle comfort.

### SUMMARY OF THE INVENTION

The problem mentioned above is solved by a friction material, a disc brake pad, as well as a braking system as outlined in the appended claims, the definitions of which form an integral part of the present description.

A first object of the invention is a friction material comprising:
from 20 to 30% by volume of one or more abrasives;
from 10 to 20% by volume of coke;
up to 10% by volume of one or more metal sulfides;
up to 20% by volume of one or more metals and/or metal alloys and/or intermetallic compounds in powder form;
up to 40% by volume of a fibrous material comprising aramid fiber and steel fiber;
from 10 to 20% by volume of phenolic resin as a binder;
up to 10% by volume of one or more fillers selected from: calcium hydroxide, friction powder, PTFE, and fluorite,
wherein said friction material does not comprise graphite.

A further object of the present invention is a pad for disc brakes comprising a friction layer intended to cooperate with the disc of a disc brake, wherein said friction layer is made of the friction material defined above.

Another object of the present invention is a braking system for disc brakes comprising a disc and a pad which comprises a friction layer intended to cooperate with said disc, wherein said friction layer is made of the friction material defined above.

It has been surprisingly found that the braking system of the invention comprising a pad the friction layer of which is made of the aforesaid friction material composition exhibits a significant decrease in the “creep groan” in terms of both intensity of the phenomenon and duration thereof, at various temperatures and various levels of relative humidity. Therefore, the friction material according to the invention proved to be particularly effective in improving the NVH behavior (Noise, Vibration and Harshness), hence the comfort level of the vehicle.

Further features and advantages of the invention will become more apparent from the description of some illustrative embodiments, given hereinbelow by way of non-limiting examples.

### BRIEF DESCRIPTION OF THE DRAWINGS

FIG. 1 shows the “Main Effect Plot” diagram, which relates the average of the assessments of the “creep groan” phenomenon (so-called “Average creep groan score”) carried out for the friction material A of the present invention and the comparison friction materials B, C, D, as the concentration of graphite in the material, the temperature and the relative humidity change.

### DETAILED DESCRIPTION OF THE INVENTION

An object of the present invention is a graphite-free friction material for brake pads which comprises specific amounts of abrasives; coke; metal sulfides; metals and/or metal alloys and/or intermetallic compounds in powder form; aramid fiber and steel fiber; phenolic resin; fillers selected from calcium hydroxide, friction powder, PTFE, and fluorite (CaF₂).

It has been surprisingly found that the absence of graphite from the aforesaid friction material considerably reduces the “creep groan” phenomenon, making it negligible. A friction material comprising the same components in the same ratios and comprising increasing amounts of graphite is subject to an increasingly intense “creep groan” phenomenon.

Preferably, the friction material according to the present invention does not comprise either graphite or graphene.

The friction material of the present invention advantageously belongs to the class of so-called “NAO” (“non-asbestos organic”) materials. The friction material of the present invention preferably belongs to the class of so-called “low-steel” materials. The friction material of the present invention preferably belongs to the class of so-called “copper-free” materials. The friction material of the present invention is preferably free, or substantially free, of asbestos, heavy metals, copper and alloys thereof.

The friction material of the present invention comprises one or more abrasives in an amount between 20 and 30% by volume.

Preferably, said friction material comprises one or more abrasives in an amount between 21 and 30% by volume, between 22 and 30% by volume, between 23 and 30% by volume, between 24 and 30% by volume, between 25 and 30% by volume, between 26 and 30% by volume, between 27 and 30% by volume, between 28 and 30% by volume, between 29 and 30% by volume.

In a preferred embodiment, said one or more abrasives are selected from the group consisting of: potassium titanate, chromite, magnesium oxide, zinc oxide, aluminum oxide, silicon carbide, and corundum.

According to this embodiment, the friction material comprises at least one of potassium titanate, chromite, magnesium oxide, zinc oxide, aluminum oxide, silicon carbide and corundum as abrasives.

Preferably, said friction material comprises potassium titanate, chromite, magnesium oxide, zinc oxide, aluminum oxide, silicon carbide and corundum as abrasives.

Said friction material may or may not comprise other abrasives in addition to those mentioned above, for example selected from zirconium, zirconium silicate, zirconium oxide, mica, talc, kaolin, barium sulfate, calcium carbonate, calcium silicate, iron oxides, mullite.

The friction material of the present invention comprises coke in an amount between 10 and 20% by volume.

Preferably, said friction material comprises coke in an amount between 11 and 20% by volume, between 12 and 20% by volume, between 13 and 20% by volume, between 14 and 20% by volume, between 15 and 20% by volume, between 16 and 20% by volume, between 17 and 20% by volume, between 18 and 20% by volume, between 19 and 20% by volume.

In an embodiment of the invention, said friction material comprises coke in an amount between 16 and 18% by volume, or between 16 and 17% by volume.

The friction material of the present invention comprises up to 10% by volume of one or more metal sulfides.

Preferably, said friction material comprises one or more metal sulfides in an amount between 5 and 10% by volume, between 6 and 10% by volume, between 7 and 10% by volume, between 8 and 10% by volume, between 9 and 10% by volume.

According to an embodiment, said friction material comprises one or more metal sulfides selected from: antimony sulfide (Sb₂S₃), molybdenum sulfide (MoS₂), tungsten sulfide (WS₂), tin sulfide (SnS, SnS₂), zinc sulfide (ZnS), iron sulfide (FeS), copper sulfide (Cu₂S), and mixed sulfides. The expression “mixed sulfides” denotes sulfides of more than one metal. In particular, the expression “mixed sulfides” denotes sulfides with metals having different valences.

According to an embodiment of the invention, said one or more metal sulfides are selected from the group consisting of FeS and SnS.

According to an embodiment of the invention, said friction material comprises at least FeS and SnS.

The friction material of the present invention comprises up to 20% by volume of one or more metals in powder form and/or metal alloys in powder form and/or intermetallic compounds in powder form.

Preferably, said friction material comprises one or more metals in powder form and/or metal alloys in powder form and/or intermetallic compounds in powder form in an amount between 5 and 20% by volume, between 5 and 15% by volume, between 5 and 10% by volume, between 6 and 10% by volume, between 7 and 10% by volume, between 8 and 10% by volume, between 9 and 10% by volume.

According to different embodiments, the intermetallic compounds can be binary intermetallic compounds or ternary intermetallic compounds.

According to an embodiment of the invention, said friction material comprises at least one of zinc in powder form and aluminum in powder form, preferably both, in the amounts by volume defined above.

According to an embodiment of the invention, said friction material comprises zinc in powder form, aluminum in powder form and at least one intermetallic compound, preferably ternary, in powder form, in the amounts by volume defined above. Said friction material may or may not comprise other metals and/or metal alloys and/or intermetallic compounds in powder form in addition to those defined above.

Said friction material may also comprise metals and/or metal alloys and/or intermetallic compounds in the form of fibers, in addition to those in the form of powder.

The friction material of the present invention comprises up to 40% by volume of a fibrous material comprising aramid fiber and steel fiber.

Preferably, said friction material comprises up to 30% by volume, or up to 20% by volume, or up to 10% by volume, of said fibrous material. For example, the friction material comprises said fibrous material in an amount between 5 and 10% by volume, between 6 and 10% by volume, between 7 and 10% by volume, between 8 and 10% by volume, between 9 and 10% by volume.

According to an embodiment, said fibrous material consists of aramid fiber and steel fiber.

According to an alternative embodiment, said fibrous material may comprise further organic and/or inorganic and/or metal fibers, in addition to aramid fiber and steel fiber, for example carbon fibers, acrylic fibers, rock wool, rock fibers, glass fibers, ceramic fibers, mineral fibers, wollastonite, copper fibers, zinc fibers, tin fibers, bronze fibers, brass fibers, iron fibers.

The friction material of the present invention comprises from 10 to 20% by volume of phenolic resin as a binder.

Preferably, said friction material comprises the aforesaid phenolic resin in an amount between 15 and 20% by volume, between 16 and 20% by volume, between 17 and 20% by volume, between 18 and 20% by volume, between 19 and 20% by volume. Preferably, said friction material comprises the aforesaid phenolic resin in an amount between 17 and 19% by volume, or between 17 and 18% by volume.

The friction material of the present invention comprises up to 10% by volume of one or more fillers selected from the group consisting of: calcium hydroxide, friction powder, PTFE, and fluorite. The expression “friction powder” denotes the powders obtained by cross-linking and subsequently grinding the liquid originating from cashew shells.

Preferably, the friction material comprises said one or more fillers in an amount between 5 and 10% by volume, between 6 and 10% by volume, between 7 and 10% by volume, between 8 and 10% by volume, between 9 and 10% by volume.

According to an embodiment, the friction material comprises calcium hydroxide, friction powder, PTFE and fluorite as fillers in the aforesaid amounts by volume.

In a specific embodiment of the invention, the friction material comprises:
from 28 to 30% by volume, preferably about 29% by volume, of potassium titanate, chromite, magnesium oxide, zinc oxide, aluminum oxide, silicon carbide and corundum as abrasives;
from 16 to 18% by volume, preferably about 17% by volume, of coke;
from 8 to 10% by volume, preferably about 9% by volume, of FeS and SnS;
from 8 to 10% by volume, preferably about 9% by volume, of zinc in powder form, aluminum in powder form and, preferably, at least one intermetallic compound in powder form, for example said intermetallic compound being ternary;
from 5 to 10% by volume, preferably about 8% by volume, of a fibrous material consisting of aramid fiber and steel fiber;
from 17 to 19% by volume, preferably from 17 to 18% by volume, of phenolic resin;
from 8 to 10% by volume, preferably between 9 and 10% by volume, of calcium hydroxide, friction powder, PTFE and fluorite as fillers,
said composition being graphite-free.

The friction material of the present invention is advantageously obtained by uniformly mixing the aforesaid components in the amounts specified above.

A further object of the present invention is a pad for disc brakes comprising a friction layer intended to cooperate with the disc of a disc brake, wherein said friction layer is made of the friction material defined above.

Said friction layer comprises a tribologically active friction surface intended to cooperate with the disc of a disc brake.

Preferably, the friction layer contained in said pad for disc brakes is obtained through a step of molding inside a suitable mold. Preferably, said molding step is carried out at a pressure between 1 and 6 bar, more preferably between 2 and 5 bar, for example about 3 bar. Preferably, said molding step is carried out at a temperature between 12° and 180° C., more preferably between 14° and 160° C., for example about 150° C. Preferably, the friction layer resulting from said molding step is subjected to post-curing by heat treatment at a temperature between 10° and 300° C. for a duration between 1 and 20 hours. Then, if necessary, it can be subjected to a second surface heat treatment called “scorching” and any mechanical machining.

Preferably, the disc brake pad of the invention further comprises a base metal plate and a substrate (or underlayer) interposed between the plate and the friction material. Preferably, said friction material, underlayer and plate are molded together using the process described above, thus obtaining the pad.

Another object of the present invention is a braking system for disc brakes comprising a disc and a pad as defined above intended to cooperate with said disc.

### Experimental Section

The friction materials A, B, C, D were prepared. Friction material A is according to the present invention and was prepared with the composition shown in Table 1; friction materials B, C, D were prepared as comparison examples and contain increasing amounts (% by volume) of graphite with respect to the volume of the composition of material A. In particular:
friction material A does not contain graphite;
friction material B contains graphite in an amount of 3% with respect to the volume of the composition of material A;
friction material B contains graphite in an amount of 5% with respect to the volume of the composition of material A;
friction material B contains graphite in an amount of 11% with respect to the volume of the composition of material A.

TABLE 1

| | A (% volume) |
|---|---|
| Abrasives (potassium titanate, chromite, | 29.2 |
| magnesium oxide, zinc oxide, aluminum | |
| oxide, silicon carbide, corundum) | |
| Coke | 16.9 |
| Graphite | 0 |
| FeS, SnS | 9.1 |
| Zinc powder, aluminum powder, | 9.2 |
| intermetallic compounds in powder form | |
| Aramid fiber, steel fiber | 8.3 |
| Phenolic resin | 17.6 |
| Fillers (calcium hydroxide, friction | 9.7 |
| powder, PTFE, fluorite) | |

Friction material A was assessed with respect to the reference materials B, C, D on a roller bench by applying variable levels of road slopes (5%, 10%, 15%, 20% both downhill and uphill) and a decreasing pressure ramp starting from the equilibrium condition.

Each test was performed according to a test matrix with different temperature levels of the braking system (from −20° C. to +250° C.) and temperature and humidity conditions of the test chamber on two levels:
temperature: 15° C., −30° C.
relative humidity: 10%, 90%

Each friction material A, B, C, D was then tested under the following test conditions:
1) 15° C., 10% humidity (hot dry);
2) 15° C., 90% humidity (hot humid);
3) −30° C., 10% humidity (cold dry);
4) −30° C., 90% humidity (cold humid).

The assessments of the friction materials A, B, C, D were carried out by assigning a score (so-called Creep Groan Score) from 2 to 10 to the materials tested under the aforesaid temperature and humidity conditions, through a function which takes into consideration the intensity and duration of the detected “creep groan” phenomenon. A higher score indicates a decrease in the “creep groan” phenomenon.

Table 2 summarizes the Creep Groan Scores obtained for the materials A, B, C, D under the four test conditions.

TABLE 2

| | | Test conditions | | | |
|---|---|---|---|---|---|
| Friction | Graphite | Hot dry | Hot humid | Cold dry | Cold humid |
| material | (% volume) | Creep Groan Score | | | |
| A | 0 | 10 | 8 | 7.5 | 6 |
| B | 3 | 7 | 5 | 6 | 3.5 |
| C | 5 | 6 | 5 | 6.5 | 4 |
| D | 11 | 3.5 | 4.5 | 5 | 4 |

As is apparent from the above table, friction material A (according to the present invention) is that with the highest scores under all test conditions. This demonstrates how the absence of graphite in the material entails a substantial decrease in the “creep groan” phenomenon.

The comparison materials B, C, D have lower scores under all test conditions; the scores decrease as the graphite content increases. A decrease in said score indicates an increase in the intensity and duration of the “creep groan” phenomenon.

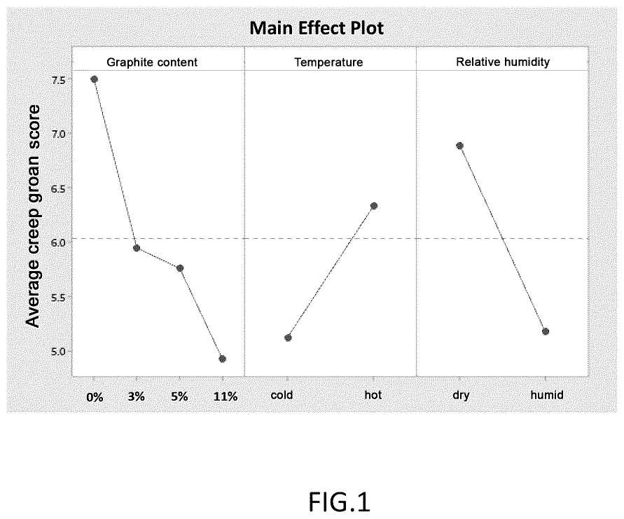

The effect of the graphite content with respect to the test conditions is also shown in the “Main Effect Plot” diagram shown in FIG. 1. It relates the average of the assessments (“Average creep groan score”) as the control parameters affecting the “creep groan” phenomenon change, i.e., graphite content, temperature, and relative humidity.

The diagram of FIG. 1 shows the worsening effect (i.e., the decrease in score) due to low temperature, high relative humidity, and presence of graphite. In particular, it is noted how the concentration of graphite is the most significant factor with respect to the assessment; indeed, changes in concentration from 0 to 11% by volume cause a score change greater than 2.5. It is also noted how the increase in the score associated with the graphite decrease is progressive as a function of the concentration.

It is apparent that what has been described is only one particular embodiment of the present invention. The person skilled in the art will be able to make all the necessary modifications to the material, to the pad and to the braking system for the adaptation thereof to particular conditions, without however departing from the scope of protection as defined in the appended claims.

1-16. (canceled)

17. A friction material comprising:
from 20 to 30% by volume of one or more abrasives;
from 10 to 20% by volume of coke;
up to 10% by volume of one or more metal sulfides;
up to 20% by volume of one or more metals and/or metal alloys and/or intermetallic compounds in powder form;
up to 40% by volume of a fibrous material comprising aramid fiber and steel fiber;
from 10 to 20% by volume of phenolic resin as a binder;
up to 10% by volume of one or more fillers selected from: calcium hydroxide, friction powder, PTFE, and fluorite,
wherein said friction material does not comprise graphite.

18. The friction material according to claim 17, wherein said one or more abrasives are selected from the group consisting of: potassium titanate, chromite, magnesium oxide, zinc oxide, aluminum oxide, silicon carbide and corundum as abrasives.

19. The friction material according to claim 17, comprising potassium titanate, chromite, magnesium oxide, zinc oxide, aluminum oxide, silicon carbide and corundum as abrasives.

20. The friction material according to claim 17, comprising said one or more abrasives in an amount between 25 and 30% by volume.

21. The friction material according to claim 17, comprising coke in an amount between 15 and 20% by volume.

22. The friction material according to claim 17, comprising one or more metal sulfides in an amount between 5 and 10% by volume.

23. The friction material according to claim 17, wherein said one or more metal sulfides are selected from FeS and SnS.

24. The friction material according to claim 17, comprising one or more metals and/or metal alloys and/or intermetallic compounds in powder form in an amount between 5 and 10% by volume.

25. The friction material according to claim 17, comprising zinc in powder form, aluminum in powder form and at least one intermetallic compound in powder form.

26. The friction material according to claim 17, comprising up to 30% by volume of said fibrous material.

27. The friction material according to claim 17, wherein said fibrous material consists of aramid fiber and steel fiber.

28. The friction material according to claim 17, comprising said phenolic resin in an amount between 15 and 20% by volume.

29. The friction material according to claim 17, comprising said one or more fillers in an amount between 5 and 10% by volume.

30. The friction material according to claim 17, comprising:
from 28 to 30% by volume of potassium titanate, chromite, magnesium oxide, zinc oxide, aluminum oxide, silicon carbide and corundum as abrasives;
from 16 to 18% by volume of coke;
from 8 to 10% by volume of FeS and SnS;
from 8 to 10% by volume of zinc in powder form, aluminum in powder form and at least one intermetallic compound in powder form;
from 5 to 10% by volume of a fibrous material consisting of aramid fiber and steel fiber;
from 17 to 19% by volume of phenolic resin;
from 8 to 10% by volume of calcium hydroxide, friction powder, PTFE and fluorite as fillers,
said composition being graphite-free.

31. A pad for disc brakes comprising a friction layer adapted to cooperate with the disc of a disc brake, wherein said friction layer is made of the friction material according to claim 17.

32. A braking system for disc brakes comprising a disc and a pad which comprises a friction layer adapted to cooperate with said disc, wherein said friction layer is made of the friction material according to claim 17.

33. The friction material according to claim 20, comprising said one or more abrasives in an amount between 28 and 30% by volume.

34. The friction material according to claim 21, comprising coke in an amount between 16 and 18% by volume.

35. The friction material according to claim 22, comprising one or more metal sulfides in an amount between 8 and 10% by volume.

36. The friction material according to claim 24, comprising one or more metals and/or metal alloys and/or intermetallic compounds in powder form in an amount between 8 and 10% by volume.

37. The friction material according to claim 26, comprising up to 20% by volume of said fibrous material.

38. The friction material according to claim 37, comprising up to 10% by volume of said fibrous material.

39. The friction material according to claim 28, comprising said phenolic resin in an amount between 17 and 19% by volume.

40. The friction material according to claim 29, comprising said one or more fillers in an amount between 8 and 10% by volume.

41. The friction material according to claim 30, comprising:
about 29% by volume of potassium titanate, chromite, magnesium oxide, zinc oxide, aluminum oxide, silicon carbide and corundum as abrasives;
about 17% by volume of coke;
about 9% by volume of FeS and SnS;
about 9% by volume of zinc in powder form, aluminum in powder form and at least one intermetallic compound in powder form;
about 8% by volume of a fibrous material consisting of aramid fiber and steel fiber;
from 17 to 18% by volume of phenolic resin;
between 9 and 10% by volume of calcium hydroxide, friction powder, PTFE and fluorite as fillers,
said composition being graphite-free.
